(19) United States
(12) Patent Application Publication
(10) Pub. No.: US 2025/0284506 A1
(43) Pub. Date: Sep. 11, 2025

(54) METHOD, APPARATUS, DEVICE, AND STORAGE MEDIUM FOR RUNNING AN APPLICATION

(71) Applicant: Beijing Zitiao Network Technology Co., Ltd., Beijing (CN)

(72) Inventors: Yu Yang, Beijing (CN); Zaojun Huang, Beijing (CN)

(21) Appl. No.: 18/963,235

(22) Filed: Nov. 27, 2024

(30) Foreign Application Priority Data
Mar. 8, 2024 (CN) 202410269129.6

(51) Int. Cl. G06F 9/451

(52) U.S. Cl. CPC G06F 9/452

(57) ABSTRACT

Embodiments of the disclosure relate to a method, an apparatus, a device, and a storage medium for running an application. The method provided herein includes: receiving, from a terminal device, a first request to launch a client of a target application, where the client is deployed in a first application platform; sending a first message to a second application platform corresponding to the target application to instruct that the target application is run at the second application platform, where the second application platform has a container for running the target application; receiving, from the second application platform, running data of the target application; and sending the running data to the terminal device to enable the terminal device to draw a running interface of the target application based on the running data.

### CROSS REFERENCE

The application claims priority to Chinese Patent Application No. 202410269129.6, filed on Mar. 8, 2024, and entitled “METHOD, APPARATUS, DEVICE, AND STORAGE MEDIUM FOR RUNNING AN APPLICATION”, the entirety of which is incorporated herein by reference.

### FIELD

Example embodiments of the present disclosure generally relate to the field of computers, and in particular to a method, an apparatus, a device, and a computer-readable storage medium for running an application.

### BACKGROUND

With the development of computer and Internet technologies, people expect to acquire diverse services by using applications running on personal communication devices. For example, a user acquires a third-party service through social applications. However, such third-party services usually have strict authorization management and control, which makes it more difficult to acquire third-party services on social applications.

### SUMMARY

In a first aspect of the present disclosure, a method for running an application is provided. The method includes: receiving, from a terminal device, a first request to launch a client of a target application, where the client is deployed in a first application platform; sending a first message to a second application platform corresponding to the target application to instruct the target application to be run at the second application platform, where the second application platform has a container for running the target application; receiving, from the second application platform, running data of the target application; and sending the running data to the terminal device to enable the terminal device to draw a running interface of the target application based on the running data.

In a second aspect of the present disclosure, an apparatus for running an application is provided. The apparatus includes: a first receiving module configured to receive, from a terminal device, a first request to launch a client of a target application, where the client is deployed in a first application platform; a first sending module configured to send a first message to a second application platform corresponding to the target application to instruct the target application to be run at the second application platform, where the second application platform has a container for running the target application; a second receiving module configured to receive, from the second application platform, running data of the target application; and a second sending module configured to send the running data to the terminal device to enable the terminal device to draw a running interface of the target application based on the running data.

In a third aspect of the present disclosure, an electronic device is provided. The electronic device includes: at least one processing unit; and at least one memory coupled to the at least one processing unit and storing instructions executable by the at least one processing unit. The instructions, when executed by the at least one processing unit, cause the electronic device to perform the method according to the first aspect.

In a fourth aspect of the present disclosure, a computer-readable storage medium is provided. A computer program is stored on the computer-readable storage medium. The computer program is executable by a processor to implement the method according to the first aspect.

It should be understood that the content described in this section is not intended to identify key features or essential features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages and aspects of various embodiments of the present disclosure will become more apparent when taken in conjunction with the drawings and with reference to the following detailed description. In the drawings, the same or similar reference numerals denote the same or similar elements, where:

FIG. 1 illustrates a schematic diagram of an example environment in which embodiments according to the present disclosure can be implemented;

FIG. 2 illustrates a flowchart of an example process of running an application according to some embodiments of the present disclosure;

FIG. 3 illustrates an interaction diagram of an example process of running an application according to some embodiments of the present disclosure;

FIG. 4 illustrates an interaction diagram of an example process of running an application according to some embodiments of the present disclosure;

FIG. 5 illustrates a schematic block diagram of an example apparatus for running an application

according to some embodiments of the present disclosure; and

FIG. 6 illustrates a block diagram of an electronic device capable of implementing multiple embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a thorough and complete understanding of the present disclosure. It should be understood that the drawings and the embodiments of the present disclosure are only for illustrative purposes and are not intended to limit the protection scope of the present disclosure.

It should be noted that the headings of any section/subsection provided herein are not limiting. Various embodiments are described throughout this document, and any type of embodiment can be included under any section/subsection. Furthermore, the embodiments described in any section/subsection may be combined in any way with any other embodiments described in the same section/subsection and/or different sections/subsections.

In the description of the embodiments of the present disclosure, the term “comprise/include” and its similar terms should be understood as open inclusion, that is, “comprise/include but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

The embodiments of the present disclosure may involve user data, data acquisition and/or use, etc. These aspects follow corresponding laws, regulations and related provisions. In the embodiments of the present disclosure, all data collection, acquisition, processing, machining, forwarding, use, etc. are performed on the premise that the user knows and confirms. Accordingly, when implementing the embodiments of the present disclosure, the user should be informed of the type, scope of use, use scenario, etc. of data or information that may be involved in an appropriate manner according to relevant laws and regulations, and the authorization of the user should be obtained. The specific manner of informing and/or authorization may vary according to actual situations and application scenarios, and the scope of the present disclosure is not limited in this respect.

The solutions in the specification and the embodiments, if involving personal information processing, will be processed on the premise of legality (for example, with the consent of the subject of personal information, or necessary for the performance of a contract, etc.), and will only be processed within a specified or agreed scope. The user's refusal to process personal information other than the necessary information required for the basic functions will not affect the user's use of the basic functions.

As described above, when people acquire third-party services through applications, such as social applications, running on personal communication devices, the people are often restricted due to authorization management and control of the services. This increases the difficulty in acquiring third-party services on social platforms.

The embodiments of the present disclosure provide a solution for running an application. According to the solution of the present disclosure, a first request to launch a client of a target application deployed in a first application platform may be received from a terminal device, and a first message may be sent to a second application platform corresponding to the target application to instruct the target application to be run at the second application platform. The second application platform has a container for running the target application. After running data of the target application is received from the second application platform, the running data may be sent to the terminal device, so that the terminal device may draw a running interface of the target application based on the image data.

In this way, the problem of authority management and control in the introduction of third-party services can be solved, thereby improving the service access efficiency and improving the user experience.

Various example implementations of this solution will be described in detail below with reference to the drawings.

### Example Environment

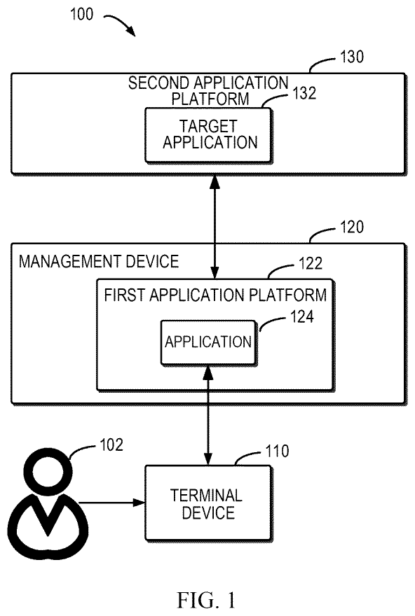

FIG. 1 illustrates a schematic diagram of an example environment 100 in which embodiments according to the present disclosure can be implemented. As shown in FIG. 1, the example environment 100 may include an electronic device 110.

In this example environment 100, the terminal device 110 may communicate with the management device 120. The management device 120 may host the first application platform 122 and manage services provided by the first application platform 120.

The second application platform 130 may host the target application 132. The second application platform 130 may be deployed with a container for running the target application 132.

The terminal device 110 may run an application 124 supporting interface interaction provided by the first application platform 122. The application 124 may be any suitable type of application for interface interaction, examples of which may include, but are not limited to, a video application, a social application, or other suitable applications. The user 102 may interact with the application via the terminal device 110 and/or its attachment device.

The first application platform 122 may provide, through the application 124, an entry for receiving to launch a client of the target application 132. For example, the user 102 may request, through an interactive interface of the application 124 presented by the terminal device 110, the application 124 to provide a service related to the target application 132.

After receiving the request from the user, the first application platform 122 (that is, the management device 120) may request to the second application platform 130 to run the target application 132, and receive running data associated with the target application 132 from the second application platform 130.

The first application platform 122 may further provide the running data associated with the target application 132 received from the second application platform 130 to the terminal device 110.

In some embodiments, the terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a handheld computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an E-book device, a game device, or any combination thereof, including accessories and peripherals of these devices or any combination thereof. In some embodiments, the terminal device 110 may also support any type of interface for the user (such as a “wearable” circuit, etc.).

Although not shown, it should be understood that the management device 120 may further include other functions or modules for supporting the first application platform 122 to acquire the service of the target application 132 from the second application platform 130. For example, the management device 120 may include an authority management module for authenticating a client of the target application 132; a transmission module for data transmission with the target application 132; a storage module for storing user data and identity information associated with the target application 132; a configuration module for providing a visual interface to configure and correlate the target application; a capability opening module for implementing platform capability events associated with the target application 132 to communicate, and/or a scheduling module for implementing service capability events associated with the target application 132, etc.

The management device 120 may be an independent physical server, a server cluster or distributed system composed of multiple physical servers, or a cloud server that provides basic cloud computing services such as cloud services, cloud databases, cloud computing, cloud functions, cloud storage, network services, cloud communication, middleware services, domain name services, security services, content distribution networks, and big data and artificial intelligence platforms. For example, the management device 120 may include a computing system/server, such as a mainframe, an edge computing node, a computing device in a cloud environment, etc. The management device 120 may provide background services for the applications supported in the terminal device 110.

A communication connection may be established between the management device 120 and the terminal device 110. The communication connection may be established by wire or wirelessly. The communication connection may include but not limited to a Bluetooth connection, a mobile network connection, a universal serial bus (USB) connection, a wireless fidelity (WiFi) connection, etc., and the embodiments of the present disclosure are not limited in this respect. In the embodiments of the present disclosure, the management device 120 and the terminal device 110 may implement signaling interaction through the communication connection therebetween.

It should be understood that the structure and function of each element in the environment 100 are described for exemplary purposes only, without implying any limitation to the scope of the present disclosure.

Some example embodiments of the present disclosure will be described below with continued reference to the drawings.

### Example Interaction Process

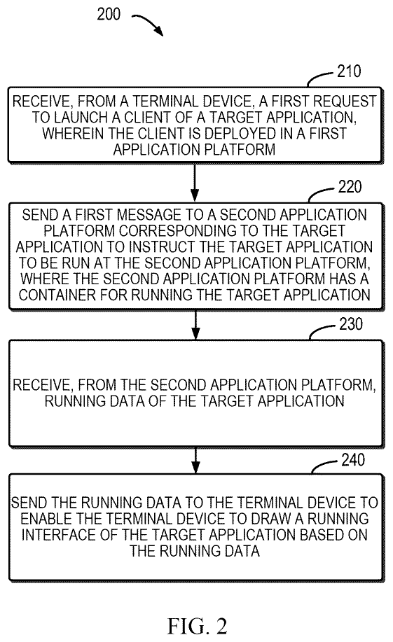

FIG. 2 illustrates a flowchart of an example process 200 of running an application according to some embodiments of the present disclosure. The process 200 may be implemented at the management device 120. The process 200 will be described below with reference to FIG. 1.

As shown in FIG. 2, at block 210, the management device 120 receives, from the terminal device 110, a first request to launch a client of the target application 132. The client is deployed in the first application platform 122.

As described above, the management device 120 provides management for the first application platform 122. The application 124 provided by the first application platform 122 may run on the terminal device 110. For example, the user 102 may receive, through an interactive interface of the application 124 presented on the terminal device 110, the first request to launch the client of the target application 132.

At block 220, the management device 120 sends a first message to a second application platform 130 corresponding to the target application 132 to instruct the target application 132 to be run at the second application platform 130.

In some embodiments, the first request may include account information of the user 102 on the application 124. The management device 120 may determine a first account of the user in the first application platform based on the first request. Based on the first account, the management device 120 may determine a second account corresponding to the first account in the second application platform 130. The second account may be understood as an account of the user 102 associated with the target application 132.

Once the second account is determined, the management device 120 may send the first message to the second application platform 130. In some embodiments, the first message may at least indicate the second account. In some other embodiments, the first message may further include description information associated with the terminal device 110.

In some embodiments, the management device 120 may obtain stored account association information. If the account association information includes an entry corresponding to the first account, the management device 120 may determine the second account corresponding to the first account based on the account association information. For example, if the user 102 previously requested or acquired the service of the target application 132 on the second application platform 130 via the first application platform 122, an association relationship between the first account and the second account may be stored on the management device 120. When the user 102 requests the service of the target application 132 on the second application platform 130 again through the first application platform 122, the management device 120 may determine the second account based on the first account and the stored association relationship.

On the contrary, if the account association information does not include an entry corresponding to the first account, for example, the user 102 has not previously requested or acquired the service of the target application 132 on the second application platform 130 via the first application platform 122, the management device 120 may request the user 102 for information associated with the second account.

In some embodiments, the management device 120 may send a second message to the terminal device 110 to instruct the terminal device 110 to present a target interface. For example, the target interface may present a prompt requiring the user to provide information associated with the second account and/or an entry for inputting the information associated with the second account. Through the target interface, the management device 120 may obtain a third message and determine the second account corresponding to the first account based on the third message. For example, the user 102 may input information related to the second account through the entry provided in the target interface. The terminal device 110 generates the third message based on the received information and sends the third message to the management device 120.

Continuing to refer to FIG. 2, at block 230, the management device 120 receives running data of the target application 132 from the second application platform 130. The running data includes at least image data corresponding to a running interface of the target application 132. In some other embodiments, the running data may further include audio data corresponding to the running interface of the target application 132.

In some embodiments, once the second application platform 130 or the management device corresponding to the second application platform 130 determines that the second account and other associated information obtained from the first message are valid, the target application 132 is allowed to run on the second application platform 130. The running data of the target application 132 is then sent to the management device 120 and hosted by the application 124 of the first application platform 122.

At block 240, the management device 120 sends running data (i.e., image data and/or audio data) of the target application 132 on the second application platform 130 to the terminal device 110 to enable the terminal device 110 to draw a running interface of the target application 132 based on the running data.

The user 102 may operate the running of the target application based on the running interface of the target application 132 drawn on the terminal device 110. In some embodiments, the terminal device 110 may acquire the user operation on the running interface and generate operation data. The management device 120 may receive the operation data from the terminal device 110 and send the operation data to the second application platform 130. The second application platform 130 controls the running of the target application according to the operation data.

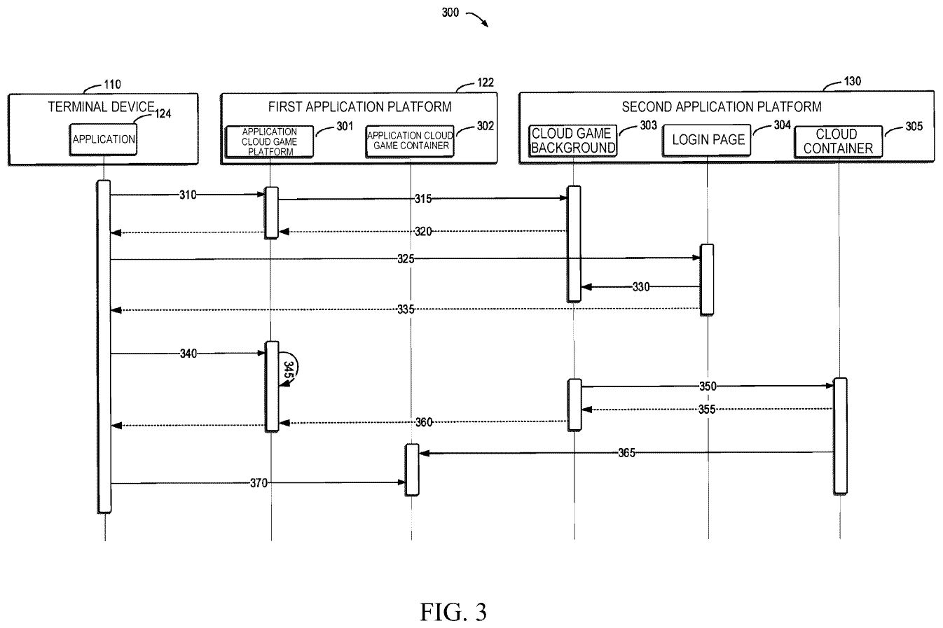

The above example process of acquiring and operating the service of the target application from the second application platform through the first application platform may be described in further detail with reference to FIG. 3.

FIG. 3 illustrates an interaction diagram of an example process 300 of running an application according to some embodiments of the present disclosure. The process 300 may involve the terminal device 110, the first application platform 122, and the second application platform 130.

In the process 300 shown in FIG. 3, the target application 132 is a cloud game service provided by the second application platform 130. Therefore, more specifically, the process 300 may involve an application 124 running on the terminal device 110 and provided by the first application platform 122, an application cloud game platform 301 and an application cloud game container 302 hosted on the first application platform 122, and a cloud game background 303, a login page 304, and a cloud container 305 hosted on the second application platform 130.

It should be understood that in addition to the cloud game service, the target application 132 may also be other applications and/or services provided by the second application platform 130. The solution of the present disclosure is not limited in this regard.

As shown in FIG. 3, in a starting phase, the application 124 running on the terminal device 110 may receive (310) a cloud game identifier and a user identity identifier and send them to the application cloud game platform 301 on the first application platform 122.

Based on the cloud game identifier and the application identifier, the application cloud game platform 301 may request (315) an address and a token for starting a cloud game from the cloud game background 303 on the second application platform 130. Once the address and the token for starting the cloud game are obtained from the cloud game background 303, the application cloud game platform 301 sends (320) the obtained address to the application 124.

Based on the received address, the application 124 sends (325) associated verification information including the cloud game identifier, the token, and the like to a login page 304 on the second application platform 130. The login page 304 then sends (330) the received information to the cloud game background 303 for verification. Once the verification is passed, the login page 304 sends (335) an indication that the login is authorized and an established chat associated with the requested service (that is, the cloud game) to the application 124. An indication that the cloud game can be started may be presented at the application 124.

The application 124 may send (340) an indication to start the game to the application cloud game platform 301. The indication may include the chat associated with the cloud game established in the application 124. The application cloud game platform 301 may store (345) the chat for subsequent login.

At the second application platform 130, the cloud game background 303 sends (350) an instruction to start the game to the cloud container 305. Once the cloud game is started, the cloud container 305 sends (355) an indication that data in the cloud container 305 is successfully scheduled to the cloud game background 303. The indication may be forwarded (360) to the application 124 via the application cloud game platform 301.

During the running of the cloud game service, the cloud container 305 may send (365) running data of the cloud game service, that is, perform audio and video streaming, to the application cloud game container 302 on the first application platform 122. Accordingly, a respective running interface may be presented on the application 124 running on the terminal device 110 based on the audio and video streaming.

The user 102 may operate the running of the cloud game service through the running interface. The operation data of the user acquired through the application 124 may be sent (370) to the application cloud game container 302.

In some embodiments, the second application platform 130 may receive a payment request for the target application 132. Still taking the target application 132 as the cloud game service as an example, the second application platform 130 may receive (for example, through the operation data of the user) a payment request for the cloud game service. The second application platform 130 may then indicate the payment request to the first application platform 122 (that is, the management device 120).

In some embodiments, the management device 120 may obtain a fourth message from the second application platform 122, where the fourth message may be generated based on a payment request initiated by the user 102 in the client of the target application 132. The management device 120 may send a fifth message to the client to instruct the client to invoke a payment module for completing the payment request.

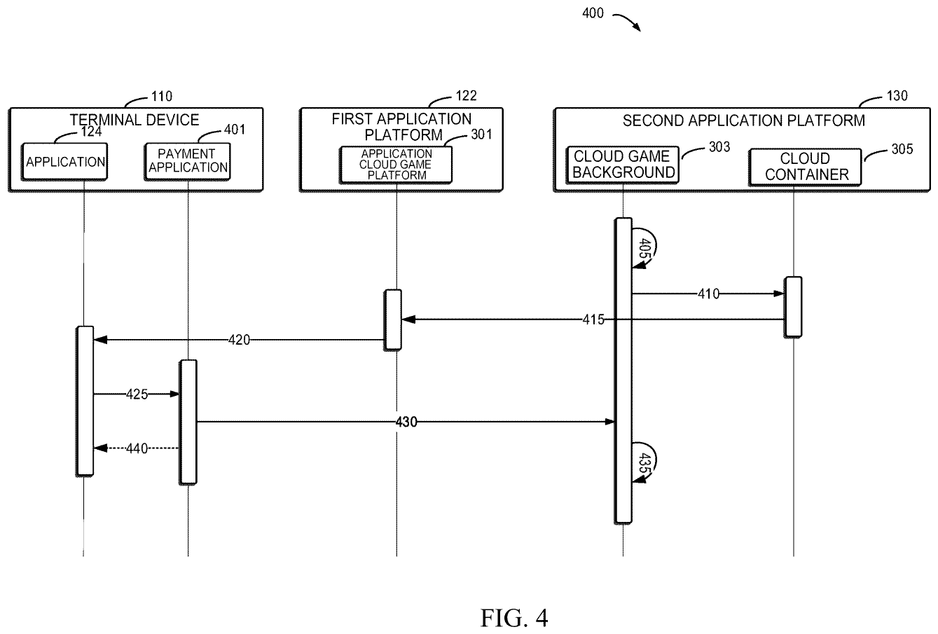

The above example process of the payment operation may be described in further detail with reference to FIG. 4.

FIG. 4 illustrates an interaction diagram of an example process 400 of running an application according to some embodiments of the present disclosure. The process 400 may involve the terminal device 110, the first application platform 122, and the second application platform 130.

In the process 400 shown in FIG. 4, the target application 132 is a cloud game service provided by the second application platform 130. Therefore, more specifically, the process 300 may involve an application 124 running on the terminal device 110 and provided by the first application platform 122, a payment application 401 running on the terminal device 110, an application cloud game platform 301 hosted on the first application platform 122, and a cloud game background 303 and a cloud container 305 hosted on the second application platform 130.

It should be understood that in addition to the cloud game service, the target application 132 may also be other applications and/or services provided by the second application platform 130. The solution of the present disclosure is not limited in this regard.

As shown in FIG. 4, if the cloud game background 303 hosted on the second application platform 130 (for example, via the client) receives a payment request for the cloud game service, a payment operation may be initiated (405) and payment information may be generated. The cloud game background 303 provides (410) the payment information to the cloud container 305.

The cloud container 305 notifies (415) the application cloud game platform 301 hosted on the first application platform 122 of the payment event. The application cloud game platform 301 forwards (420) the payment event to the application 124.

At the terminal device 110, the application 124 may initiate (425) a payment operation to the payment application 401 running on the terminal device 110. The payment application 401 may report (430) the payment status of the payment operation to the cloud game background 303. Once the cloud game background 303 determines that the payment is successful, it provides (435) the service or object corresponding to the payment operation to the user.

In addition, the payment application 401 may report (440) the payment status of the payment operation to the application 124, so as to present an indication of payment success or failure to the user through a flat interactive interface provided by the application 124.

In some other embodiments, if it is determined that the target application is removed from the second application platform, the management device 120 may remove the client of the target application from the first application platform. In some other embodiments, if it is determined that an additional application is available in the second application platform, the management device 120 may also add, in the first application platform, an additional client corresponding to the additional application.

The solution provided by the embodiments of the present disclosure can get through the channel for acquiring, on the first application platform, the service provided by the application running on the second application platform. In this way, the problem of authority management and control in the introduction of third-party services can be solved, thereby improving the service access efficiency and improving the user experience.

### Example Apparatus and Device

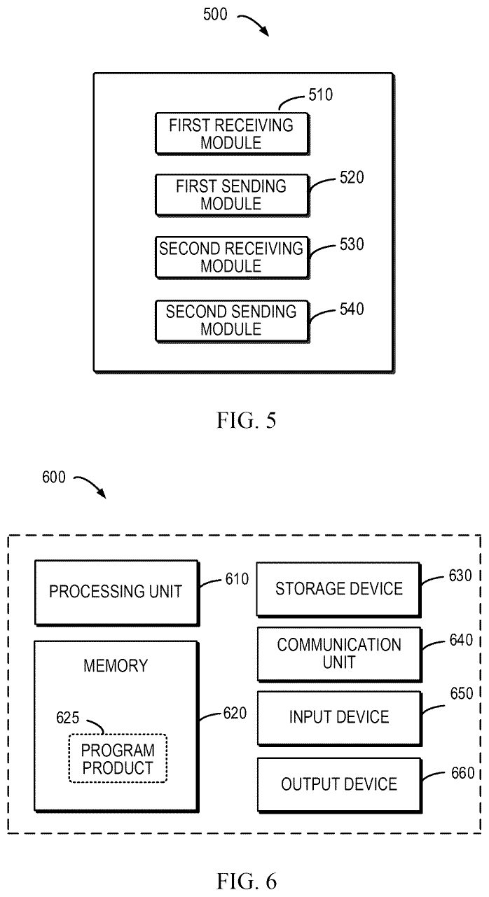

The embodiments of the present disclosure further provide corresponding apparatuses for implementing the above methods or processes. FIG. 5 illustrates a schematic block diagram of an example apparatus 500 for running an application according to some embodiments of the present disclosure. The apparatus 500 may be implemented as or included in the management device 120. Respective modules/components in the apparatus 500 may be implemented by hardware, software, firmware, or any combination thereof.

As shown in FIG. 5, the apparatus 500 includes a first receiving module 510 configured to receive, from a terminal device, a first request to launch a client of a target application, where the client is deployed in a first application platform; a first sending module 520 configured to send a first message to a second application platform corresponding to the target application to instruct the target application to be run at the second application platform, where the second application platform has a container for running the target application; a second receiving module 530 configured to receive running data of the target application from the second application platform; and a second sending module 540 configured to send the running data to the terminal device to enable the terminal device to draw a running interface of the target application based on the running data.

In some embodiments, the apparatus 500 further includes: a third receiving module configured to receive, from the terminal device, operation data, where operation data is generated based on a user operation on the running interface; and a third sending module configured to send the operation data to the second application platform to enable the second application platform to control the running of the target application based on the operation data.

In some embodiments, the first sending module 520 is further configured to: determine, based on the first request, a first account of a user in the first application platform; determine a second account corresponding to the first account in the second application platform; and send the first message to the second application platform, where the first message indicates at least the second account.

In some embodiments, the first sending module 520 is further configured to: obtain stored account association information; and determine, in response to the account association information including an entry corresponding to the first account, the second account corresponding to the first account based on the account association information.

In some embodiments, the first sending module 520 is further configured to: in response to the account association information not including an entry corresponding to the first account, send a second message to the terminal device to instruct the terminal device to present a target interface; and determine the second account corresponding to the first account based on a third message obtained from the terminal device, where the third message is determined based on an operation of the user on the target interface.

In some embodiments, the first message includes description information associated with the terminal device.

In some embodiments, the apparatus 500 further includes: an obtaining module configured to: obtain a fourth message from the second application platform, where the fourth message is generated based on a payment request initiated by a user in the client; and a fourth sending module configured to: send a fifth message to the client to instruct the client to invoke a payment module for completing the payment request.

In some embodiments, the apparatus 500 further includes: a removing module configured to: remove the client of the target application from the first application platform in response to the target application being removed from the second application platform; or an adding module configured to: add, in the first application platform, an additional client corresponding to an additional application in response to the additional application being available in the second application platform.

In some embodiments, the target application includes a game application, and the running data includes image data corresponding to a running interface of the target application and/or audio data of the target application.

FIG. 6 illustrates a block diagram of an electronic device 600 in which one or more embodiments of the present disclosure can be implemented. It should be understood that the electronic device 600 shown in FIG. 6 is only illustrative and should not constitute any limitation to the functions and scope of the embodiments described herein. The electronic device 600 shown in FIG. 6 may be used to implement the management device 120 in FIG. 1.

As shown in FIG. 6, the electronic device 600 is in the form of a general electronic device. The components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and can perform various processes according to a program stored in the memory 620. In a multi-processor system, multiple processing units execute computer-executable instructions in parallel to improve the parallel processing capability of the electronic device 600.

The electronic device 600 generally includes multiple computer storage media. Such media may be any available media accessible by the electronic device 600, including but not limited to volatile and non-volatile media, and removable and non-removable media. The memory 620 may be a volatile memory (for example, a register, a cache, a random-access memory (RAM)), a non-volatile memory (for example, a read-only memory (ROM), an electrically erasable programmable read-only memory (EEPROM), a flash memory), or some combination thereof. The storage device 630 may be a removable or non-removable medium and may include a machine-readable medium, such as a flash drive, a disk, or any other medium, which may be capable of storing information and/or data and may be accessed within the electronic device 600.

The electronic device 600 may further include additional removable/non-removable, volatile/non-volatile storage medium. Although not shown in FIG. 6, a disk drive for reading from or writing to a removable, non-volatile disk (for example, a “floppy disk”) and an optical disk drive for reading from or writing to a removable, non-volatile optical disk may be provided. In these cases, each drive may be connected to a bus (not shown) by one or more data medium interfaces. The memory 620 may include a computer program product 625 having one or more program modules configured to perform various methods or actions of various embodiments of the present disclosure.

The communication unit 640 enables communication with other electronic devices through a communication medium. Additionally, the functions of the components of the electronic device 600 may be implemented in a single computing cluster or multiple computing machines that can communicate through communication connections. Therefore, the electronic device 600 may operate in a networked environment using a logical connection with one or more other servers, network personal computers (PCs), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required, the external devices such as storage devices, display devices, etc., communicate with one or more devices that enable the user to interact with the electronic device 600, or communicate with any device (for example, a network card, a modem, etc.) that enables the electronic device 600 to communicate with one or more other electronic devices. Such communication may be performed via an input/output (I/O) interface (not shown).

According to an example implementation of the present disclosure, a computer-readable storage medium is provided, which has computer-executable instructions stored thereon, and the computer-executable instructions are executed by a processor to implement the method described above. According to an example implementation of the present disclosure, a computer program product is further provided, which is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, the apparatus, the device, and the computer program product implemented according to the present disclosure. It should be understood that each block of the flowchart and/or the block diagram and the combination of blocks in the flowchart and/or the block diagram may be implemented by computer-readable program instructions.

These computer-readable program instructions may be provided to the processing unit of a general computer, a special computer, or other programmable data processing apparatus, so as to produce a machine, and these instructions, when executed by the processing unit of the computer or other programmable data processing apparatus, produce an apparatus for implementing the functions/actions specified in one or more blocks in the flowchart and/or the block diagram. These computer-readable program instructions may also be stored in a computer-readable storage medium, and these instructions enable the computer, the programmable data processing apparatus, and/or other devices to work in a specific way, so that the computer-readable medium storing the instructions includes an article of manufacture, which includes instructions for implementing various aspects of the functions/actions specified in one or more blocks in the flowchart and/or the block diagram.

The computer-readable program instructions may be loaded onto a computer, other programmable data processing apparatus, or other device, causing a series of operational steps to be performed on the computer, other programmable data processing apparatus, or other device to produce a computer-implemented process, such that the instructions which, when executed on the computer, other programmable data processing apparatus, or other device, implement the functions/actions specified in one or more blocks in the flowcharts and/or block diagrams.

The flowcharts and block diagrams in the drawings illustrate possible architectures, functions, and operations of the system, method, and computer program product according to multiple implementations of the present disclosure. In this regard, each block in the flowchart or block diagram may represent a module, a program segment, or a portion of an instruction, which includes one or more executable instructions for implementing specified logical functions. In some alternative implementations, the functions marked in the blocks may also occur in a different order than the order marked in the drawings. For example, two consecutive blocks may actually be executed substantially in parallel, or they may sometimes be executed in a reverse order, depending on the functions involved. It should also be noted that each block in the block diagram and/or flowchart, and a combination of blocks in the block diagram and/or flowchart, may be implemented by a dedicated hardware-based system that performs the specified functions or actions, or may be implemented by a combination of dedicated hardware and computer instructions.

Various implementations of the present disclosure have been described above, and the above description is illustrative, not exhaustive, and is not limited to the disclosed implementations. Many modifications and variations are obvious to those of ordinary skill in the art without departing from the scope and spirit of the described implementations. The selection of terms used herein is intended to best explain the principles, practical applications or improvements of the technologies in the market, or to enable other ordinary skill in the art to understand various implementations disclosed herein.

What is claimed is:

1. A method for running an application, comprising:
receiving, from a terminal device, a first request to launch a client of a target application, wherein the client is deployed in a first application platform;
sending a first message to a second application platform corresponding to the target application to instruct the target application to be run at the second application platform, wherein the second application platform has a container for running the target application;
receiving, from the second application platform, running data of the target application; and
sending the running data to the terminal device to enable the terminal device to draw a running interface of the target application based on the running data.

2. The method according to claim 1, further comprising:
receiving, from the terminal device, operation data, wherein the operation data is generated based on a user operation on the running interface; and
sending the operation data to the second application platform to enable the second application platform to control running of the target application based on the operation data.

3. The method according to claim 1, wherein sending the first message to the second application platform corresponding to the target application comprises:
determining, based on the first request, a first account of a user in the first application platform;
determining a second account corresponding to the first account in the second application platform; and
sending the first message to the second application platform, wherein the first message indicates at least the second account.

4. The method according to claim 3, wherein determining the second account corresponding to the first account in the second application platform comprises:
obtaining stored account association information; and
determining, in response to the account association information comprising an entry corresponding to the first account, the second account corresponding to the first account based on the account association information.

5. The method according to claim 4, wherein determining the second account corresponding to the first account in the second application platform comprises:
in response to the account association information not comprising an entry corresponding to the first account, sending a second message to the terminal device to instruct the terminal device to present a target interface; and
determining the second account corresponding to the first account based on a third message obtained from the terminal device, wherein the third message is determined based on an operation of the user on the target interface.

6. The method according to claim 1, wherein the first message comprises description information associated with the terminal device.

7. The method according to claim 1, further comprising:
obtaining a fourth message from the second application platform, wherein the fourth message is generated based on a payment request initiated by a user in the client; and
sending a fifth message to the client to instruct the client to invoke a payment module for completing the payment request.

8. The method according to claim 1, further comprising:
in response to the target application being removed from the second application platform, removing the client of the target application from the first application platform; or
in response to an additional application being available in the second application platform, adding, in the first application platform, an additional client corresponding to the additional application.

9. The method according to claim 1, wherein the target application comprises a game application, and the running data comprises image data corresponding to the running interface of the target application and/or audio data of the target application.

10. The method according to claim 1, the first application platform is comprised in a management device.

11. An electronic device, comprising:
at least one processing unit; and
at least one memory coupled to the at least one processing unit and storing instructions executable by the at least one processing unit, wherein the instructions, when executed by the at least one processing unit, cause the electronic device to perform acts comprising:
receiving, from a terminal device, a first request to launch a client of a target application, wherein the client is deployed in a first application platform;
sending a first message to a second application platform corresponding to the target application to instruct the target application to be run at the second application platform, wherein the second application platform has a container for running the target application;
receiving, from the second application platform, running data of the target application; and
sending the running data to the terminal device to enable the terminal device to draw a running interface of the target application based on the running data.

12. The electronic device according to claim 11, the acts further comprise:
receiving, from the terminal device, operation data, wherein the operation data is generated based on a user operation on the running interface; and
sending the operation data to the second application platform to enable the second application platform to control running of the target application based on the operation data.

13. The electronic device according to claim 11, wherein sending the first message to the second application platform corresponding to the target application comprises:
determining, based on the first request, a first account of a user in the first application platform;
determining a second account corresponding to the first account in the second application platform; and
sending the first message to the second application platform, wherein the first message indicates at least the second account.

14. The electronic device according to claim 13, wherein determining the second account corresponding to the first account in the second application platform comprises:
obtaining stored account association information; and
determining, in response to the account association information comprising an entry corresponding to the first account, the second account corresponding to the first account based on the account association information.

15. The electronic device according to claim 14, wherein determining the second account corresponding to the first account in the second application platform comprises:
in response to the account association information not comprising an entry corresponding to the first account, sending a second message to the terminal device to instruct the terminal device to present a target interface; and
determining the second account corresponding to the first account based on a third message obtained from the terminal device, wherein the third message is determined based on an operation of the user on the target interface.

16. The electronic device according to claim 11, wherein the first message comprises description information associated with the terminal device.

17. The electronic device according to claim 11, the acts further comprise:
obtaining a fourth message from the second application platform, wherein the fourth message is generated based on a payment request initiated by a user in the client; and
sending a fifth message to the client to instruct the client to invoke a payment module for completing the payment request.

18. The electronic device according to claim 11, the acts further comprise:
in response to the target application being removed from the second application platform, removing the client of the target application from the first application platform; or
in response to an additional application being available in the second application platform, adding, in the first application platform, an additional client corresponding to the additional application.

19. The electronic device according to claim 11, wherein the target application comprises a game application, and the running data comprises image data corresponding to the running interface of the target application and/or audio data of the target application.

20. A non-transitory computer-readable storage medium having a computer program stored thereon, wherein the computer program is executable by a processor to implement acts comprising:
receiving, from a terminal device, a first request to launch a client of a target application, wherein the client is deployed in a first application platform;
sending a first message to a second application platform corresponding to the target application to instruct the target application to be run at the second application platform, wherein the second application platform has a container for running the target application;
receiving, from the second application platform, running data of the target application; and
sending the running data to the terminal device to enable the terminal device to draw a running interface of the target application based on the running data.
